(19) United States
(12) Patent Application Publication
(10) Pub. No.: US 2003/0005891 A1
(43) Pub. Date: Jan. 9, 2003

(54) Solid dog waste collecting sheet

(76) Inventor: Lin Lu, Wayne, PA (US)

Correspondence Address: Lin Lu, 100 Eaton Drive, Wayne, PA, 19087, US

(21) Appl. No.: 09/900,548

(22) Filed: Jul. 9, 2001

(51) Int. Cl. A01K 23/00

(52) U.S. Cl. 119/867

(57) ABSTRACT

A sheet for collecting solid dog waste while the dog is being walked outside including a square plastic film with rounded corners, a string going through the four folded edges, and a circular paper stuck in the center of the plastic film. The solid dog waste will be eliminated on the sheet, so the ground or lawn will remain clean. Using this sheet, dog owners will keep their hands away from touching the solid dog waste. They will not feel dirty anymore. The product is low in cost; disposal is easy.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates to an apparatus for use in collecting solid dog waste while the dog is being walked outside.

2. Description of the Related Art

A plastic bag is the most popular apparatus for picking up solid dog waste from the street, sidewalk, or lawn. However, at times dog owners forego picking up the waste, one reason being it is distasteful to them to handle it. Also, the dog waste cannot be picked up totally if it is very soft. Some of it will stick to the ground or the grass.

Sometimes a small shovel is used to pick up solid dog waste. Some of the waste will still stick to the ground or the grass. Also, the shovel needs to be cleaned for reuse.

There are a few other products that relate to collecting solid dog waste like DISPOZ-A-SCOOP, Poop Disposal Scooper, etc. They still do not solve the problem of some remaining dog waste on the ground or lawn. The other disadvantage of these products is their high price. The selling price cannot be dropped because of the cost the materials used.

### BRIEF SUMMARY OF THE INVENTION

It is, therefore, an object of the present invention to provide an apparatus that can be easily used in collecting solid dog waste while the dog is being walked outside.

It is another object of the present invention to provide a low-cost apparatus of simple design and ease of manufacture for easy and clean collection of solid dog waste.

It is still another object of the present invention to protect the beauty of our environment.

The main advantages of the present invention are that it is easy to use, clean, and economical.

In accordance with one aspect of the present invention, collecting solid dog waste is very easy. The task can be done in only two steps.

According to another aspect of the present invention, collecting solid dog waste is very clean. The dog will eliminate on the present invention, so nothing will be stuck to the ground or lawn. It keeps the street or lawn very clean. Also, dog owners do not need to touch the dog waste. It is odor and hassle-free.

According to yet another aspect of the present invention, is that it is made of plastic film, paper, and string. The materials are cheap and the production is easy. These aspects make the product low in cost and easy for trash disposal.

The above, and other objects, features, and advantages of the present invention will be apparent from the following detailed description of illustrative embodiments thereof, which is to be read in connection with the accompanying drawings wherein.

### BRIEF DESCRIPTION OF THE SEVERAL VIEWS OF THE DRAWING

FIG. 1 is a plan view of the present invention.

FIG. 2 through FIG. 5 show how the present invention is used.

### DETAILED DESCRIPTION OF THE INVENTION

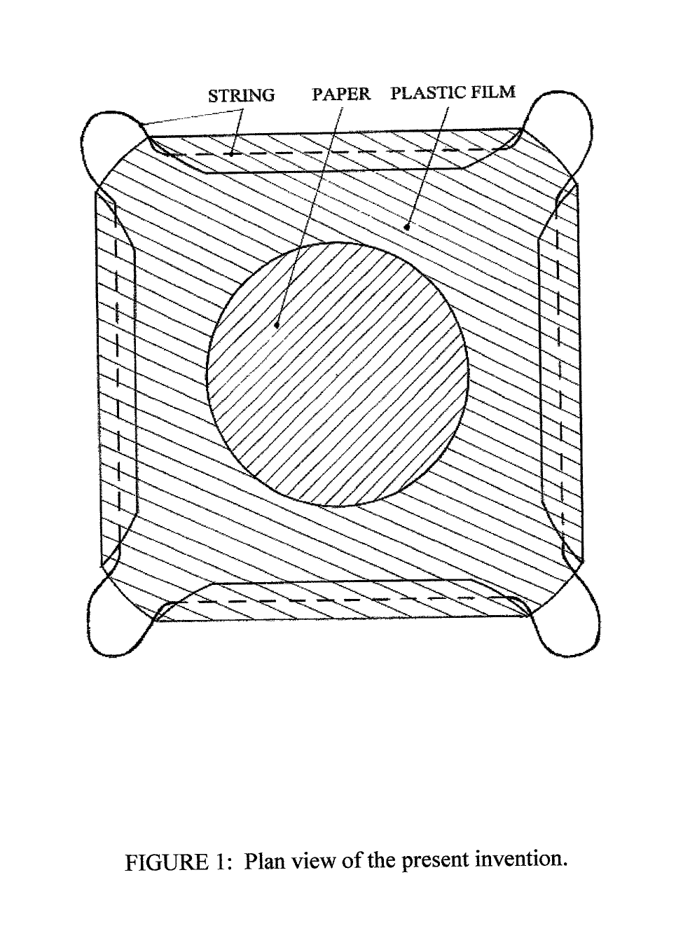

Referring to FIG. 1, the present invention is made of three materials: plastic film, paper, and string. A round-shaped paper is stuck in the center of the plastic sheet and used to support the plastic sheet. It makes the use easier. Also, the product name and logo can be printed on the paper. The plastic sheet is square with rounded corners. The rounded corners are important. It eases the closure of the sheet. The four edges of the plastic sheet are folded to hold the string. The string can be lifted from all four corners, so the dog owner can enclose the solid dog waste by tying the string from any of the two opposite corners. Then, the string is used for carrying the solid dog waste that is enclosed in the plastic sheet.

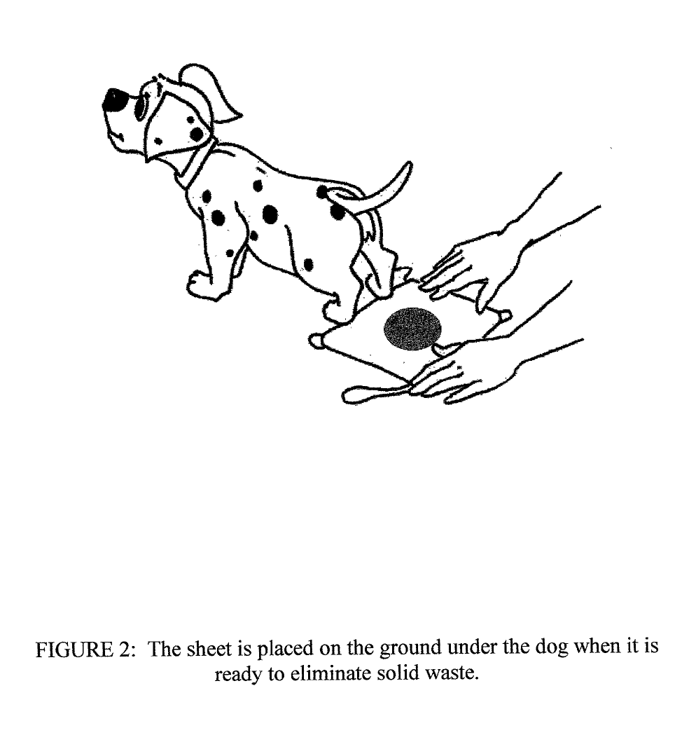

Referring to FIG. 2, it shows the first step of using the current invention. The sheet is put on the ground under the dog when dog owner sees that the dog is ready to eliminate. The position of the sheet does not matter as long as it is centered under the dog.

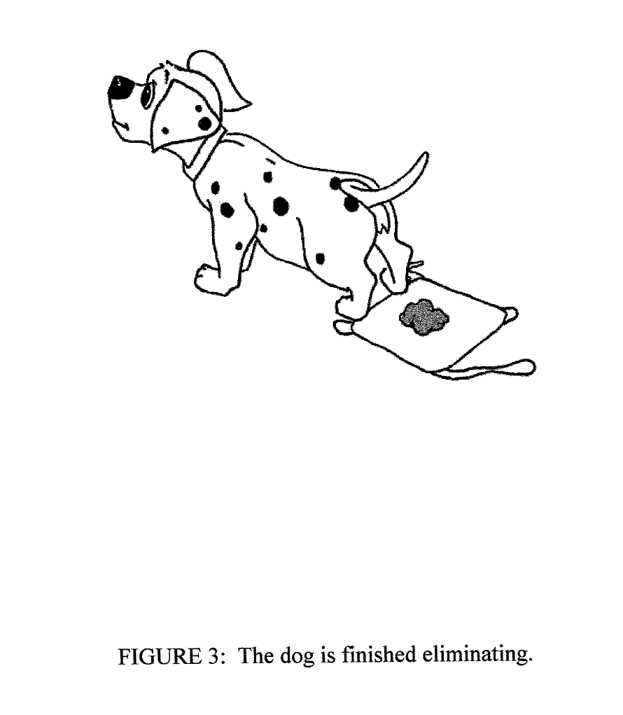

Referring to FIG. 3, the dog has finished eliminating on the sheet.

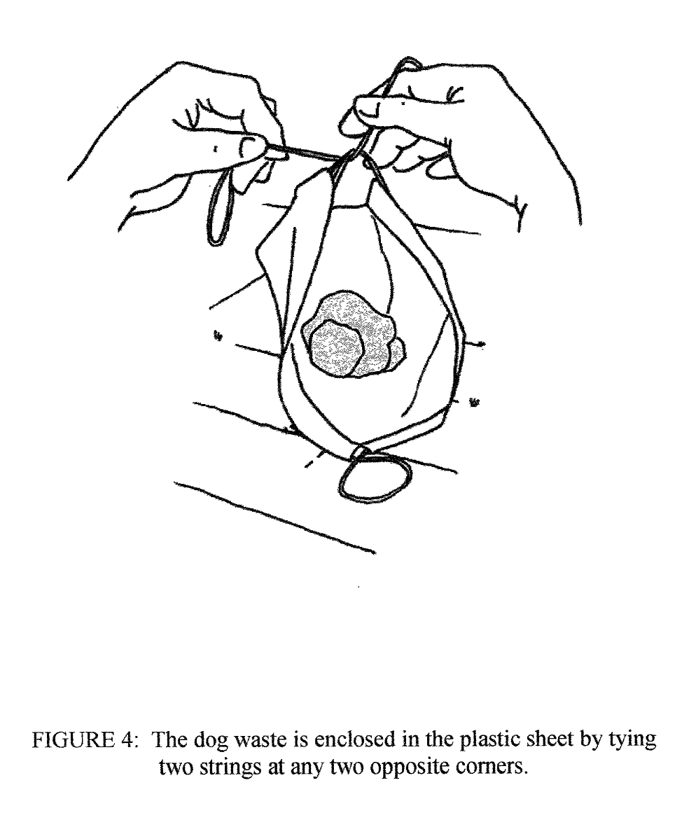

Referring to FIG. 4, it shows the second step of using the current invention. Any two strings at opposite corners are lifted and tied loosely together.

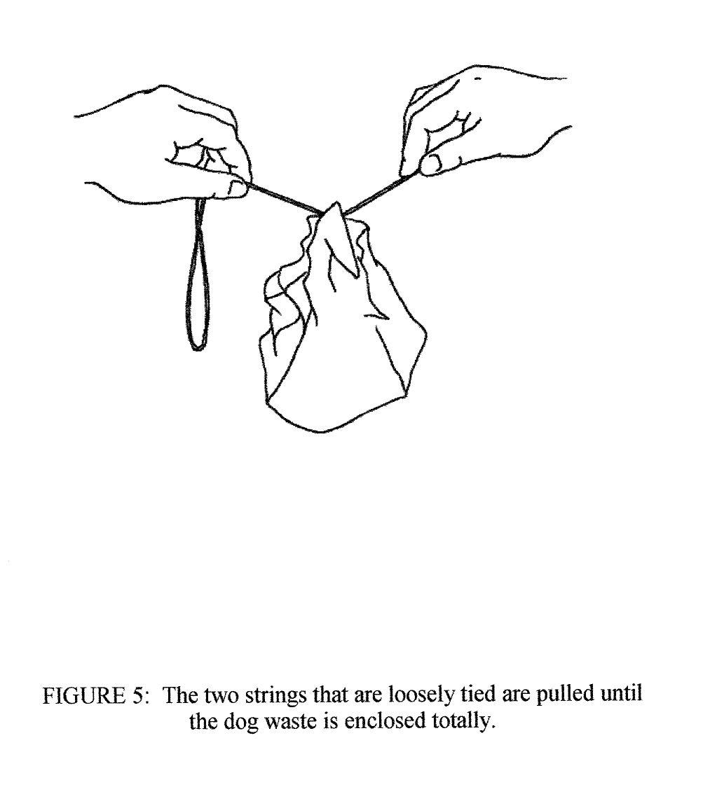

Referring to FIG. 5, the dog waste is totally enclosed when the two strings that are loosely tied are pulled. It is ready to be disposed.

Although illustrative embodiments of the present invention have been described herein in connection with the accompanying drawings, it is to be understood that this invention is not limited to these embodiments and that various changes and modifications or alternative uses may be effected therein by those skilled in the art without departing from the spirit of the invention.

I claim:

1. An apparatus comprising:
a collecting plastic sheet;
a string;
a circular sheet of paper.

2. An apparatus according to claim 1, wherein the perimeters of said collecting plastic sheet is square with rounded corners.

3. An apparatus according to claim 1, further comprising of said string is going through the four folded edges is used to enclose solid dog waste and to carry the sheet with solid dog waste enclosed in it;

4. An apparatus according to claim 1, further comprising of said circular reinforcing sheet of paper stuck in the center of the sheet.

5. An apparatus according to claim 1, alternative comprising of said circular sheet of paper could be removed to reduce the production cost and selling price.
